(19) United States
(12) Patent Application Publication
(10) Pub. No.: US 2025/0228263 A1
(43) Pub. Date: Jul. 17, 2025

(54) Method for Controlling an Ice Cream Maker

(71) Applicant: Guangdong Link Plus Technology Group Co., Ltd., Foshan (CN)

(72) Inventors: Long Li, Foshan (CN); Hua Sheng Lai, Foshan (CN); Pan Chen, Foshan (CN)

(21) Appl. No.: 18/430,992

(22) Filed: Feb. 2, 2024

(30) Foreign Application Priority Data
Jan. 11, 2024 (CN) 202410045964.1

(51) Int. Cl. A23G 9/12; A23G 9/20; A23G 9/22; A47J 43/044; A47J 43/07; A47J 43/08

(52) U.S. Cl. CPC A23G 9/12; A23G 9/20; A23G 9/224; A23G 9/228; A47J 43/044; A47J 43/0711; A47J 43/082

(57) ABSTRACT

The present invention discloses a control method for an ice cream maker. During operation, the ice cream maker enters an operating state and controls a motor to drive an upper body from a first position to a second position based on a pressure value F and a weight value G, performing at least one downward churning stroke and one upward mixing stroke. A paddle head not only churns an ice cream material in the cup, but also ascends and performs a reverse mixing process after churning. In this mixing process, the churned ice cream material can be thoroughly mixed with air to increase the air saturation of the ice cream material, which enhances the flavor of the ice cream.

### FIELD OF INVENTION

The present invention relates to a method for controlling an ice cream maker.

### BACKGROUND OF THE PRESENT INVENTION

Prior art, such as the Chinese invention patent document with publication number CN216674577U, discloses a micro-fruit puree machine comprising a housing, a platform, a positioning motor, and a driving motor. The platform is movably positioned in the housing between a first position and a second position. The positioning motor is installed on the housing and coupled to the platform so that the positioning motor can move the platform between the first and second positions. The driving motor rotates a power shaft relative to the platform, and the driving motor is mounted on the platform so that the driving motor can move with the power shaft between the first and second positions in accordance with the positioning motor.

In the prior art, the platform is moved up and down by the positioning motor, and the purpose of the platform movement is to drive a paddle head down to churn the ice cream material in the bowl component. However, in the prior art, the paddle head moves directly from the first position to the second position under the drive of the positioning motor, resulting in insufficient mixing of the churned ice cream material. The saturation of the churned ice cream material is uneven, leading to a less desirable flavor. Moreover, the motor moves directly from the first position to the second position while continuously churning downward without deceleration, which can easily lead to motor damage.

In addition, the prior art does not provide a means to regulate the movement and rotation of the paddle head according to the weight of the ice cream material. If the paddle head continues to operate at the machine's predetermined speed regardless of the weight of the ice cream material, this could result in suboptimal churning efficiency that needs to be improved.

Furthermore, in the prior art, the platform is moved up and down by the positioning motor, and the driving motor is responsible for driving the power shaft to rotate the paddle head. This dual-drive method has the disadvantage of high manufacturing and maintenance costs. Moreover, the platform moves the power shaft up and down under the drive of the positioning motor. During this process, the power shaft will move from the inside of the machine housing to the outside to churn the material, and then returns to the housing after churning. This movement can cause material remaining on the power shaft during churning to move back into the housing, posing problems such as bacterial growth and material accumulation, which can lead to odor problems. Additionally, this structural arrangement of the paddle shaft positions the power shaft inside the housing when the machine is shut down, making it inconvenient for cleaning.

### SUMMARY OF THE PRESENT INVENTION

The present invention aims to address at least one technical problem existing in the prior art. To accomplish this, the present invention proposes a control method for an ice cream maker that utilizes churning and mixing to increase the air saturation of the ice cream material.

According to this purpose, a control method for an ice cream maker is designed. The ice cream maker comprises a lower body and an upper body. The upper body is movably disposed relative to the lower body, with a placement area between the lower body and the upper body for placing a cup. A rotatable paddle shaft is disposed on the upper body above the placement area, with a paddle head at the lower end of the paddle shaft.

Inside the ice cream maker is provided with a screw lifting mechanism that drives the upper body to move up and down relative to the lower body.

The upper body houses a motor having a first output shaft and a second output shaft. The first output shaft is drivingly connected to the paddle shaft, and the second output shaft is drivingly connected to the screw lifting mechanism.

The lower body is equipped with a weighing module in contact with the cup, which senses the weight of the cup and outputs a weight value as G.

The paddle shaft is slidably provided with a cup cover that can cover the cup, and a compression spring is sheathed on the paddle shaft. An upper end of the compression spring is in contact with the upper body, and above the compression spring on the upper body, a pressure sensor is in close contact with the compression spring. The lower end of the compression spring can be in close contact with the upper end face of the cup cover and transmit pressure to the detection end of the pressure sensor in real time. The pressure sensor is used to detect the real-time pressure of the compression spring and output a pressure value as F.

The control method of the ice cream maker comprises: the ice cream maker enters an operating state and controls the motor to drive the upper body from the first position to the second position based on the pressure value F and the weight value G. The movement of the upper body from the first position to the second position includes at least one downward churning stroke and one upward mixing stroke.

In comparison to the prior art, the ice cream maker performs at least one downward churning stroke and one upward mixing stroke during operation. Not only does the paddle head churn the ice cream material in the cup during operation, but the paddle head also ascends and performs a reverse mixing process after churning. This mixing process allows the churned ice cream material to be thoroughly mixed with air to increase the air saturation of the ice cream material, which enhances the flavor of the ice cream.

The present invention employs a dual-axis motor to simultaneously drive the paddle shaft and the screw lifting mechanism to achieve a single-motor drive. This can reduce manufacturing and replacement costs in the future maintenance process when components are damaged. In addition, the movable upper body allows the paddle shaft to remain exposed at all times, which facilitates the cleaning of residues on the paddle shaft to prevent bacterial growth and material accumulation, and makes the ice cream maker easy to clean.

### BRIEF DESCRIPTION OF THE DRAWINGS

FIG. 1 is a schematic diagram of the planar structure of the upper body in the first position;

FIG. 2 is a schematic diagram of the sectional structure of the upper body in the first position;

FIG. 3 is a schematic diagram of the planar structure of the upper body in the second position;

FIG. 4 is a schematic diagram of the sectional structure of the upper body in the second position;

FIG. 5 is one of the schematic diagrams of the partial structure of the present invention;

FIG. 6 is another schematic diagram of the partial structure of the present invention;

FIG. 7 is a planar structure schematic diagram of the paddle head in the present invention;

FIG. 8 is another planar structure schematic diagram of the paddle head in the present invention;

FIG. 9 is a run chart of the movement of the upper body between the first and second positions; and

FIG. 10 is an operational principles diagram of the ice cream maker.

### DETAILED DESCRIPTION OF THE PREFERRED EMBODIMENTS

The present invention, a control method for an ice cream maker, will be further described below in conjunction with the accompanying drawings and embodiments.

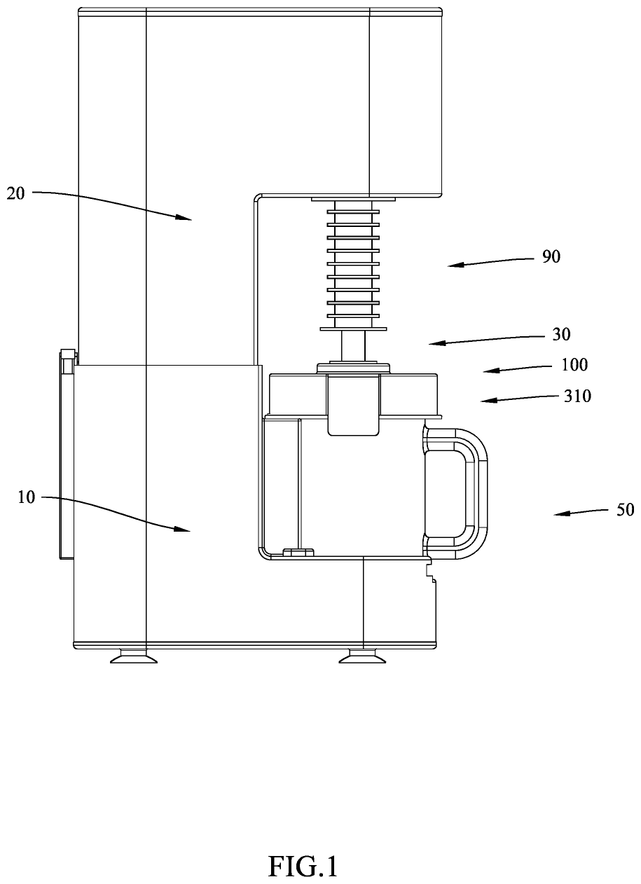

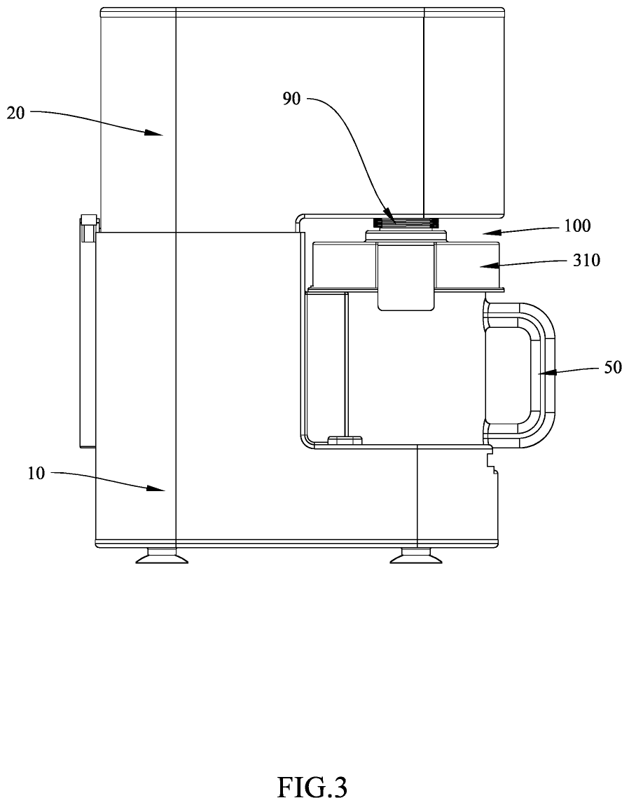

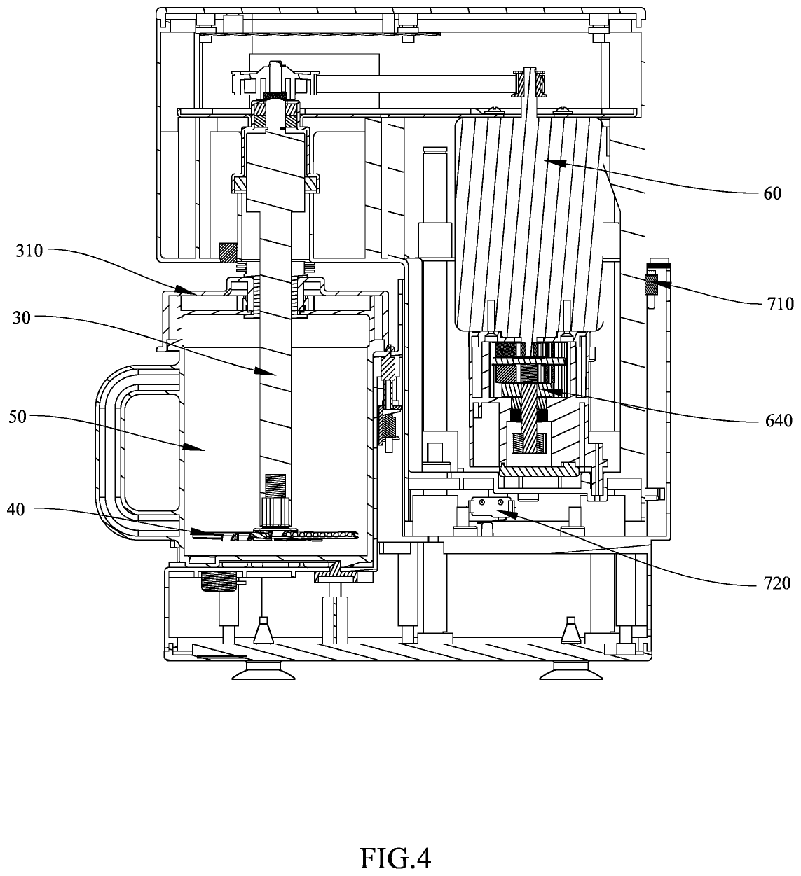

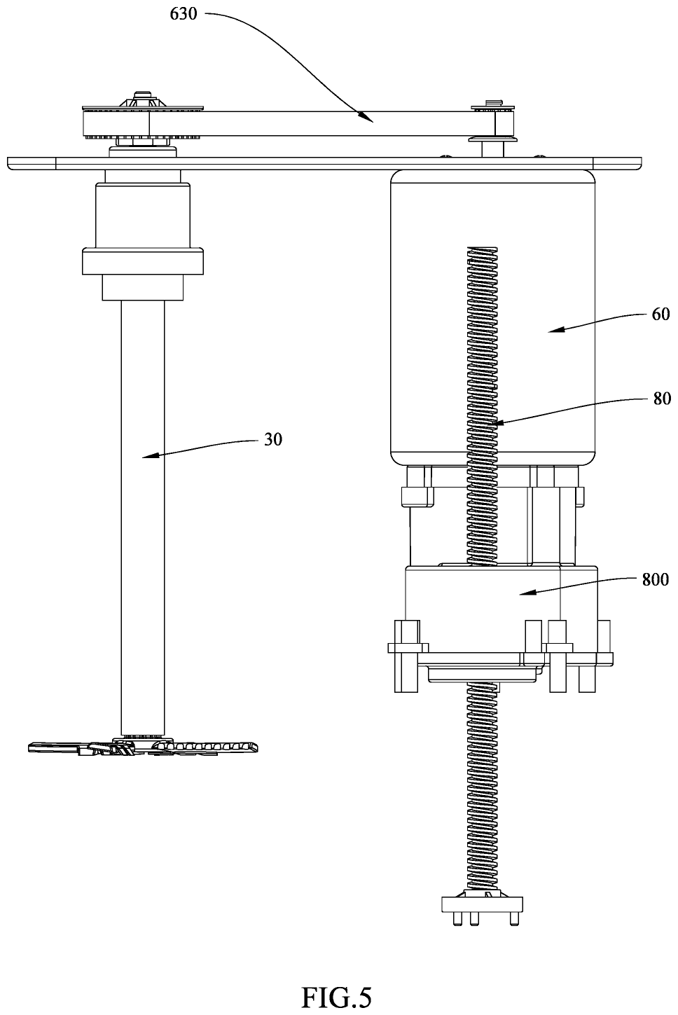

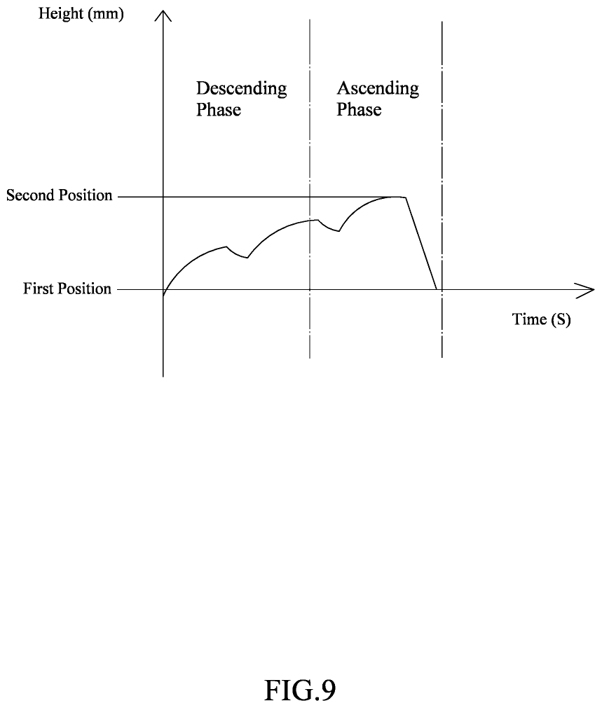

Referring to FIGS. 1-9, wherein the ice cream maker comprises a lower body and an upper body 20. The upper body 20 is movably disposed relative to the lower body 10, with a placement area 100 between the lower body 10 and the upper body 20 for placing a cup 50. A rotatable paddle shaft 30 is disposed on the upper body above the placement area 100, with a paddle head 40 at the lower end of the paddle shaft 30.

Inside the ice cream maker, a screw lifting mechanism 80 is provided which drives the upper body 20 to move up and down relative to the lower body 10. The screw lifting mechanism 80 comprises a screw 801 fixedly installed inside the lower body 10 and extending upwardly into the upper body 20. A screw nut 810 is rotatably disposed inside the upper body 20, the screw nut 810 is threadedly connected to the screw 801, and the second output shaft 620 is drivingly connected to the screw nut 810.

The upper body 20 houses a motor 60 having a first output shaft 610 and a second output shaft 620. The first output shaft 610 is drivingly connected to the paddle shaft 30, and the second output shaft 620 is drivingly connected to the screw nut 810.

The motor 60 drives the upper body 20 to move up and down relative to the lower body 10 between the first and second positions, and drives the paddle shaft 30 to rotate in the forward or reverse direction.

The ice cream maker is provided with a first microswitch 710 and a second microswitch 720. The upper body 20 is sensed with the first microswitch 710 when in the first position, and the upper body 20 is sensed with the second microswitch 720 when in the second position.

The lower body 10 is equipped with a weighing module 530 in contact with the cup 50. The weighing module 530 senses the weight of the cup 50 and outputs a weight value as G.

The paddle shaft 30 is provided with a cup cover 310 that can cover the cup 50. A compression spring 90 is sheathed on the paddle shaft 30, with an upper end in contact with the upper body 20. Above the compression spring 90 on the upper body 20, a pressure sensor 910 is in close contact with the compression spring 90. The lower end of the compression spring 90 can be in contact with the upper end face of the cup cover 310 and transmit pressure to the detection end of the pressure sensor 910 in real time. The pressure sensor 910 is used to detect the real-time pressure of the compression spring 90 and outputs a pressure value as F.

The control method of the ice cream maker comprises: the ice cream maker enters an operating state and controls the motor 60 to drive the upper body 20 from the first position to the second position based on the pressure value F and the weight value G. The movement of the upper body from the first position to the second position includes at least one downward churning stroke and one upward mixing stroke.

In the downward churning stroke, the upper body 20 moves downward relative to the lower body 10 and the paddle shaft 30 rotates in a first direction. In the upward mixing stroke, the upper body 20 moves upward relative to the lower body 10 and the paddle shaft 30 rotates in a second direction.

In the downward churning stroke, the rotation speed of the paddle shaft 30 is V1=K1×F, the downward speed of the upper body 20 is V2=X×V1, and the downward time is T1.

In the upward mixing stroke, the rotation speed of the paddle shaft 30 is V3=K2×F, the upward speed of the upper body 20 is V4=X×V3, and the upward time is T2.

Wherein, K1 is a forward rotation coefficient, K2 is a backward rotation coefficient, X is a motion coefficient, F is a pressure value, and K1 and K2 are both inversely proportional to G, wherein the inverse ratio setting can achieve a smaller K value when the weight value G is larger. This means that when the ice mixture in the cup is heavier, the rotation speed and downward speed of the paddle shaft will be slower, thus achieving intelligent churning and descent based on the weight of the ice mixture, which not only improves the flavor of the ice cream but also effectively protects the motor.

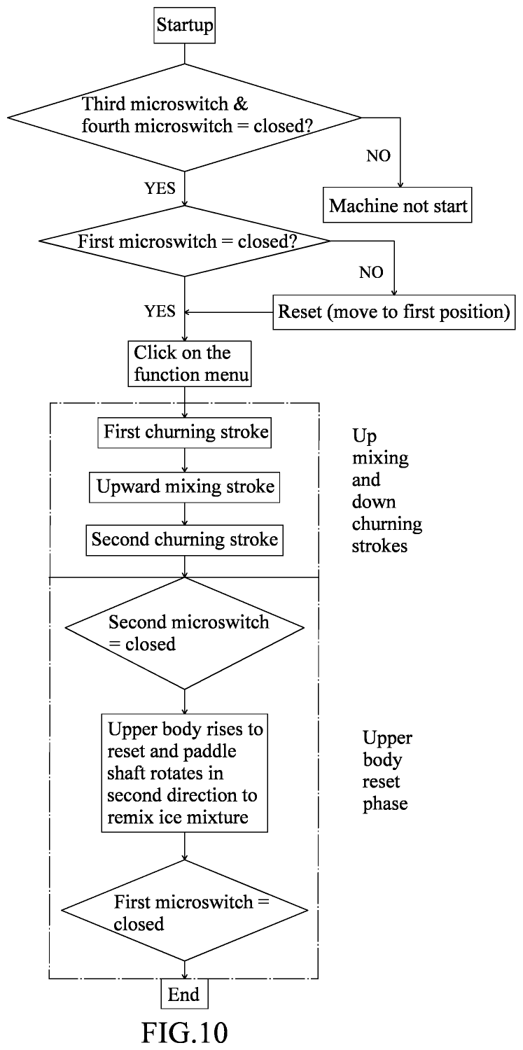

Referring to FIG. 10, the operations of the ice cream maker are as follows:

S1: The motor 60 drives the upper body 20 to perform the first downward churning stroke.

In the first downward churning stroke, the upper body 20 moves downward relative to the lower body 10 and the paddle shaft 30 rotates in the first direction. During this rotation, the shaving blade edge of the paddle head 40 contacts the ice mixture to perform a grinding action.

S2: Upon completion of the first downward churning stroke, the upward mixing stroke is carried out.

In the upward mixing stroke, the upper body 20 moves upward relative to the lower body 10 and the paddle shaft 30 rotates in the second direction. During this rotation, the paddle head 40 moves upward, and during the rotation, the mixing blade edge disperses the shaved ice mixture such that the ice mixture can be thoroughly mixed with the air in the cup.

S3: Upon completion of the upward mixing stroke, the second downward churning stroke is carried out.

In the second downward churning stroke, the upper body 20 moves downward relative to the lower body 10 and the paddle shaft 30 rotates in the first direction. During this rotation, the shaving blade edge of the paddle head 40 contacts the ice mixture to perform the grinding action.

S4: Cycling through steps S1˜S3 until the upper body 20 moves to the second position to control the motor 60 to drive the upper body 20 to move from the second position to the first position and to rotate the paddle shaft 30 in the second direction to remix the ice mixture, thereby completing the operation.

In the present invention, the first output shaft 610 is drivingly connected to the paddle shaft 30 by a belt 630, and the second output shaft 620 is drivingly connected to the screw nut 810 by an epicyclic gear set 640.

Furthermore, X is 0.03 to achieve a slower upper body movement speed than the paddle shaft rotation speed, allowing the paddle head to move slowly during high-speed grinding to ensure sufficient ice shaving.

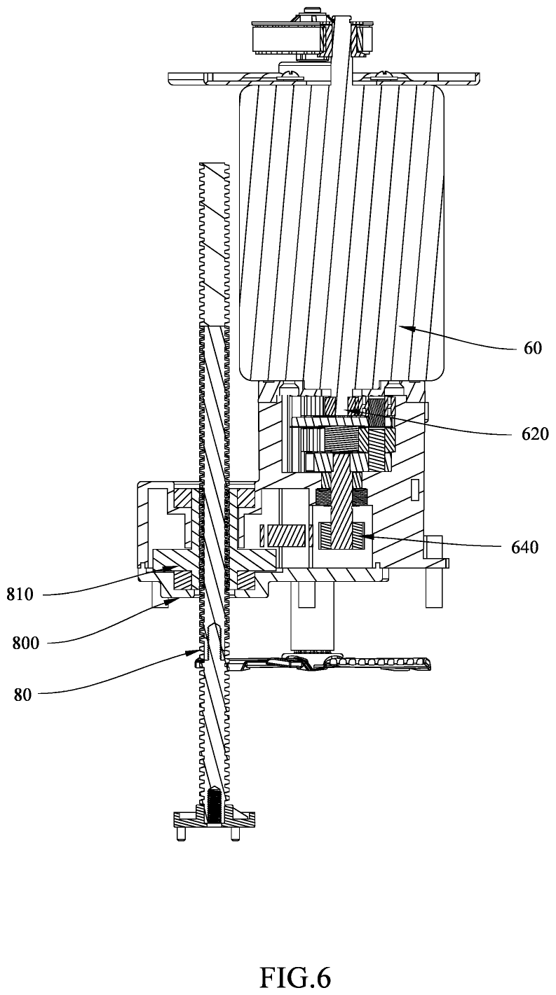

Referring to FIG. 6, an installation shell 800 is fixedly installed within the upper body 20, and the screw nut 810 is rotatably disposed within the installation shell 800. The installation shell 800 may be assembled into the upper body 20 using screws.

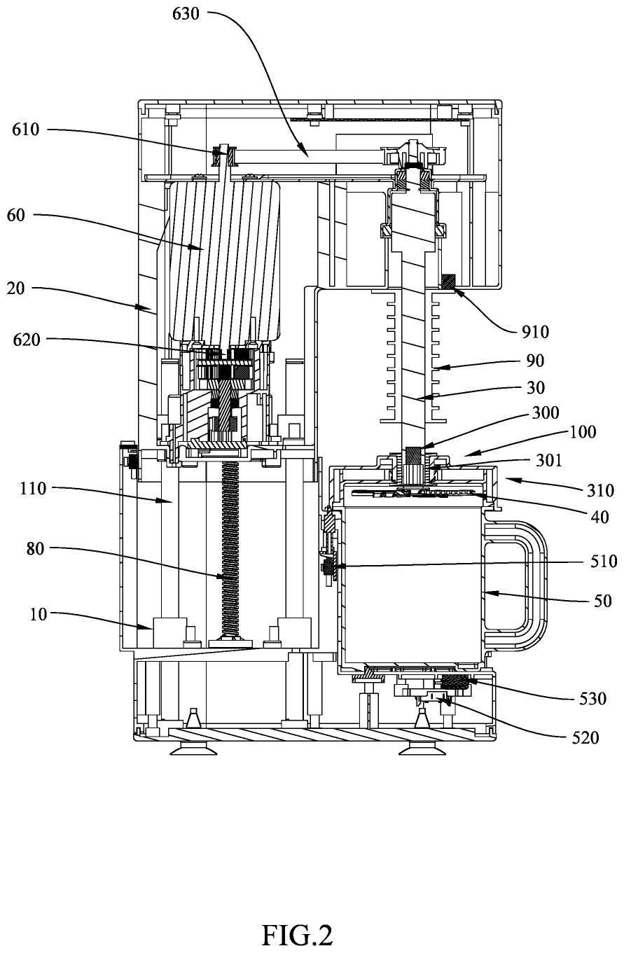

Referring to FIG. 2, guide columns 110 are installed within the lower body 10, and the upper body 20 is slidably connected to the guide columns 110. During ascent and descent, the upper body 20 moves relative to the guide columns 110.

In the present invention, the paddle shaft 30 is magnetically coupled to the paddle head 40.

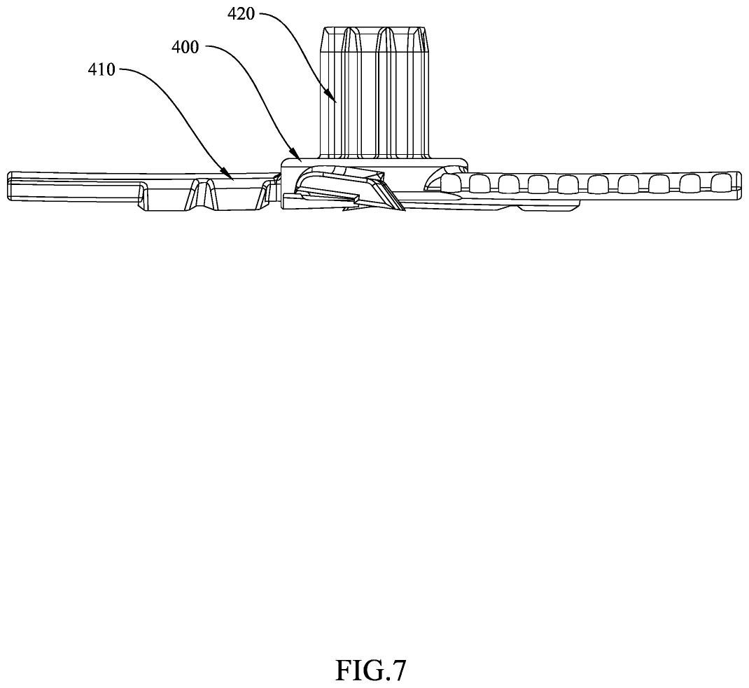

Referring to FIGS. 2 and 7, the lower end of the paddle shaft 30 is provided with a coupling cavity 301, and a coupling portion 420 is provided on the paddle head 40. The coupling portion 420 is inserted into the coupling cavity 301, and a magnetic member magnetically attracting with the coupling portion 420 is provided in the coupling cavity 301.

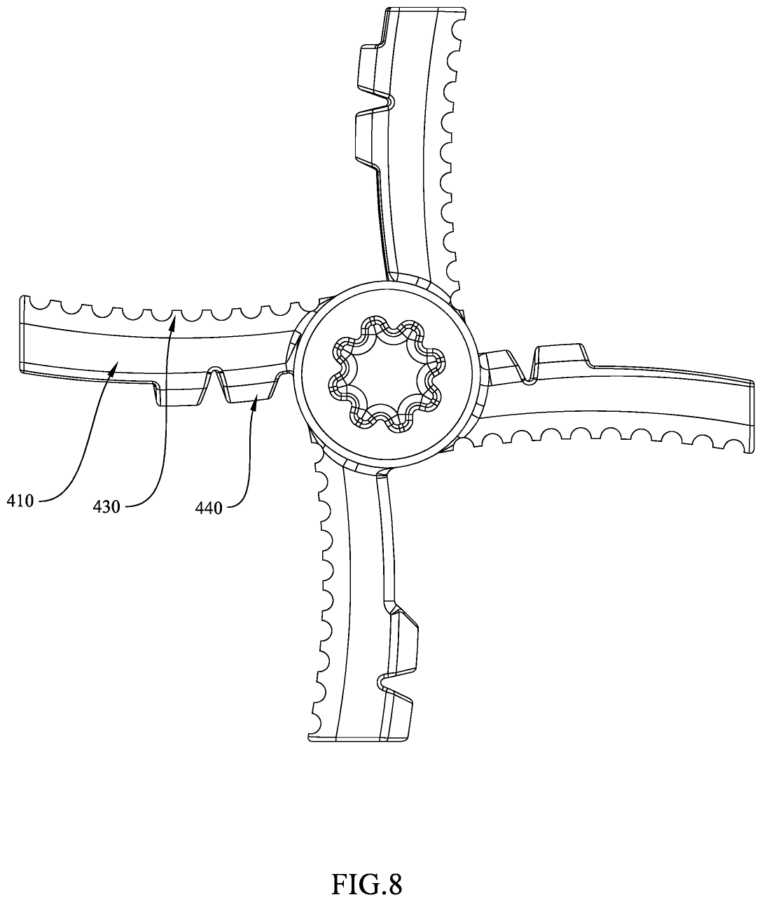

Referring to FIG. 8, the paddle head 40 comprises a paddle disc 400. The coupling portion 420 is disposed on the paddle disc 400, and multiple blades 410 are arranged along the circumferential array of the paddle disc 400. The blades 410 are each provided with ice shaving blade edges 440 and mixing blade edges 430 on opposite sides.

During the descent of the paddle head 40, the paddle head 40 rotates forward and the ice shaving blade edges 440 grind and shave the ice cream material in the cup 50 to convert the top surface of the ice block to a fine ice mixture. As the paddle head 40 ascends and reverses, the mixing blade edges 430 come into contact with the ice mixture. In this process, the mixing blade edges 430 can effectively disperse the shaved ice mixture, allowing the ice mixture to be thoroughly mixed with the air in the cup, making the ice mixture denser and thus improving the flavor of the ice cream.

The placement area 100 is provided with a third microswitch 520 and a fourth microswitch 510 for detecting the cup 50.

It should be understood that the contents not described in detail in this specification are known to those skilled in the art.

In the description of the present invention, it should be understood that terms such as “center”, “longitudinal”, “lateral”, “length”, “width”, “thickness”, “top”, “bottom”, “front”, “rear”, “left”, “right”, “vertical”, “horizontal”, “upper”, “lower”, “inner”, “outer”, “clockwise”, “counterclockwise”, etc., indicate the orientation or positional relationship based on the orientation or positional relationship shown in the drawings. These terms are used for descriptive purposes and are not to be construed as limiting, indicating, or implying any particular orientation, construction or operation for the devices or components referred to. Therefore, it should be understood that the terms “first,” “second,” etc., are used for descriptive purposes only and do not imply or suggest any relative importance or indicate the quantity of technical features indicated.

The foregoing illustrates and describes the basic principles and main features of the present invention and its advantages. Those skilled in the art should understand that the present invention is not limited to the embodiments described above. The embodiments and descriptions in the specification are intended only to illustrate the principles of the present invention. Within the scope and spirit of the present invention, various modifications and improvements may be made which fall within the scope of protection defined by the appended claims and their equivalents.

What is claimed is:

1. A control method for an ice cream maker, wherein the ice cream maker comprises a lower body (10) and an upper body (20), and the upper body (20) is movably disposed relative to the lower body (10), a placement area (100) for placing a cup (50) is provided between the lower body (10) and the upper body (20), and a rotatable paddle shaft (30) is provided on the upper body (20) above the placement area (100), with a paddle head (40) at the lower end of the paddle shaft (30);
a screw lifting mechanism (80) is provided inside the ice cream maker to drive the upper body (20) to move up and down relative to the lower body (10);
a motor (60) is provided within the upper body (20), the motor (60) has a first output shaft (610) and a second output shaft (620), the first output shaft (610) is drivingly connected to the paddle shaft (30), and the second output shaft (620) is drivingly connected to the screw lifting mechanism (80);
a weighing module (530) for contacting the cup (50) is equipped on the lower body (10), and the weighing module (530) senses the weight of the cup (50) and outputs a weight value as G;
a cup cover (310) coverable on the cup (50) is provided on the paddle shaft (30), a compression spring (90) is sheathed on the paddle shaft (30) with an upper end in contact with the upper body (20), and a pressure sensor (910) in close contact with the compression spring (90) is provided on the upper body (20) above the compression spring (90), the lower end of the compression spring (90) is in close contact with the upper end face of the cup cover (310), and a real-time pressure is transmitted to the detection end of the pressure sensor (910), and the pressure sensor (910) is used to detect the real-time pressure of the compression spring (90) and output a pressure value as F;
the control method of the ice cream maker comprises: the ice cream maker entering an operating state and controlling the motor (60) to drive the upper body (20) from a first position to a second position based on the pressure value F and the weight value G, and the movement of the upper body (20) from the first position to the second position including at least one downward churning stroke and one upward mixing stroke.

2. The control method for an ice cream maker according to claim 1, wherein:
in the downward churning stroke, the upper body (20) moves downward relative to the lower body (10) and the paddle shaft (30) rotates in a first direction;
in the upward mixing stroke, the upper body (20) moves upward relative to the lower body (10) and the paddle shaft (30) rotates in a second direction.

3. The control method for an ice cream maker according to claim 2, wherein:
in the downward churning stroke, the rotation speed of the paddle shaft (30) is V1=K1×F, the downward speed of the upper body (20) is V2=X×V1, and the downward time is T1;
in the upward mixing stroke, the rotation speed of the paddle shaft (30) is V3=K2×F, the upward speed of the upper body (20) is V4=X×V3, and the upward time is T2;
wherein, K1 is a forward rotation coefficient, K2 is a backward rotation coefficient, X is a motion coefficient, F is a pressure value, and K1 and K2 are both inversely proportional to G.

4. The control method for an ice cream maker according to claim 1, wherein: the paddle shaft (30) is magnetically coupled to the paddle head (40).

5. The control method for an ice cream maker according to claim 4, wherein: the lower end of the paddle shaft (30) is provided with a coupling cavity (301), and a coupling portion (420) is provided on the paddle head (40), the coupling portion (420) is inserted into the coupling cavity (301), and a magnetic member (300) magnetically attracting with the coupling portion (420) is provided in the coupling cavity (301).

6. The control method for an ice cream maker according to claim 5, wherein: the paddle head (40) comprises a paddle disc (400), the coupling portion (420) is disposed on the paddle disc (400), and multiple blades (410) are arranged along the circumferential array of the paddle disc (400), each of the blades (410) being provided with ice shaving blade edges (440) and mixing blade edges (430) on opposite sides.

7. The control method for an ice cream maker according to claim 1, wherein: the placement area (100) is provided with a third microswitch (520) and a fourth microswitch (510) for detecting the cup (50).

8. The control method for an ice cream maker according to claim 1, wherein: the screw lifting mechanism (80) comprises a screw (801) fixedly installed inside the lower body (10), the screw (801) extends upward into the upper body (20), a screw nut (810) is rotatably disposed inside the upper body (20), the screw nut (810) is threadedly connected to the screw (801), and the second output shaft (620) is drivingly connected to the screw nut (810).

9. The control method for an ice cream maker according to claim 1, wherein: the ice cream maker is provided with a first microswitch (710) and a second microswitch (720), the upper body (20) is sensed with the first microswitch (710) when in the first position, and the upper body (20) is sensed with the second microswitch (720) when in the second position.
